(19) United States
(12) Patent Application Publication
(10) Pub. No.: US 2006/0243951 A1
(43) Pub. Date: Nov. 2, 2006

(54) Electrochromic copolymer

(76) Inventor: Hsing-Lin Wang, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(21) Appl. No.: 11/173,473

(22) Filed: Jun. 30, 2005

Related U.S. Application Data
(60) Provisional application No. 60/676,543, filed on Apr. 28, 2005.

(51) Int. Cl. H01B 1/12

(52) U.S. Cl. 252/500

(57) ABSTRACT

Electrochromic polyamides are prepared by condensation polymerization. The polyamides are soluble in common organic solvents. Thin films of the polyamides adhere strongly to indium tin oxide (ITO) glass and do not delaminate even after hundred of redox cycles.

### RELATED APPLICATIONS

This application claims the benefit of U.S. Provisional Patent Application Ser. No. 60/676,543 filed Apr. 28, 2005, incorporated by reference herein.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to electrochromic materials and more particularly to an electrochromic polyamide material.

### BACKGROUND OF THE INVENTION

Polyaniline (PANI) is an organic conducting polymer that has shown promise for commercial applications due to its low cost, fast switching in redox states, and environmental stability. Some of the potential applications for PANI include rechargeable batteries [1], electrochromic displays [2], chemical and electromechanical actuators [3], anti-corrosion coatings [4], and electromagnetic interference shielding [5]. PANI, however, is generally a difficult material to process because of its limited solubility [6]. For these reasons, it has become important to develop better methods for processing PANI, to synthesize derivatives of PANI that are easier to process, and to invent other conducting polymers that are easier to process than PANI.

One of the better methods for processing PANI involves doping PANI with an organic acid. Doping PANI with an organic acid having a bulky alkyl group (camphorsulfonic acid (CSA), dodecylbenzenesulfonic acid (DBSA), or acrylimido-2-methyl-1-propanesulfonic acid (AMPS), for example) improves the solubility in organic solvents such as DMF or DMSO [7]. Soluble derivatives of PANI have been prepared from alkyl-substituted and alkoxy-substituted monomers [8].

One approach for preparing PANI involves using highly concentrated solutions of emeraldine base (EB) that include a small amount of a gel inhibitor. The gel inhibitor is believed to disrupt interchain H-bonding interactions. Highly concentrated solutions (greater than about 20 weight percent of emeraldine base) have been prepared using this approach [9].

Another processing method involves incorporating aniline oligomer segments into the polymer backbone. Using this approach, the properties of the polymer may be altered by adjusting the chain length of the oligomer segments [10]. Some materials prepared this way have better physical properties than those for high molecular weight conducting polymers [11].

There remains a need for conducting polymers that may be processed more easily than PANI.

Accordingly, an object of the present invention is to provide a conducting polymer that may be processed more easily than PANI.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention includes a polymeric reaction product of a compound of the formula 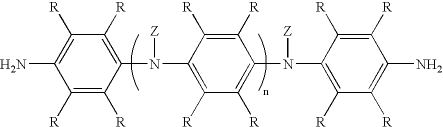
with a compound of formula X(O═)C—R′—C(═O)X;
wherein n is an integer greater than 2; wherein R is independently selected from hydrogen, alkyl having 1-12 carbon atoms, aryl, alkyl-substituted aryl, alkoxy having 1-4 carbon atoms, fluoroalkyl having 1-12 carbon atoms, fluoride, chloride, bromide, and iodide; wherein Z is independently selected from hydrogen and —(C═O)OR″ wherein R″ is alkyl having 1-12 carbon atoms; wherein R′ is selected from alkyl having 1-12 carbon atoms, aryl, alkyl-substituted aryl, fluoroalkyl, and fluoroaryl; and wherein X is selected from the group consisting of F, Cl, Br, I, and OH.

The invention also includes a method for preparing a thin film. The method involves dissolving the polymeric reaction product of a first compound and a second compound in a solvent to produce a solution, then casting a film of the solution on a surface, and evaporating the solvent. The first compound has the formula 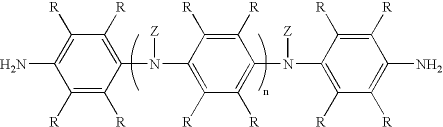
wherein n is an integer greater than 2; wherein R is independently selected from hydrogen, alkyl having 1-12 carbon atoms, aryl, alkyl-substituted aryl, alkoxy having 1-4 carbon atoms, fluoroalkyl having 1-12 carbon atoms, fluoride, chloride, bromide, and iodide; and wherein Z is independently selected from hydrogen and —(C═O)OR″ wherein R″ is alkyl having 1-12 carbon atoms. The second compound has the formula
X(O═)C—R′—C(═O)X
wherein R′ is selected from alkyl having 1-12 carbon atoms, aryl, alkyl-substituted aryl, fluoroalkyl, and fluoroaryl; and wherein X is selected from the group consisting of F, Cl, Br, I, and OH.

### BRIEF DESCRIPTION OF THE DRAWINGS

The accompanying drawings, which are incorporated in and form a part of the specification, illustrate the embodiment(s) of the present invention and, together with the description, serve to explain the principles of the invention. In the drawings:

FIG. 1 shows cyclic voltammagrams of copolymers I, II, III, IV and polyaniline. The voltammagrams were obtained in an aqueous 1.0 M HCl solution using Ag/Ag⁺ as reference electrode with a scanning rate of 50 mV/sec.

FIG. 2 shows a representation of the polymer backbone for copolymer II of this invention as it undergoes oxidation and reduction.

FIG. 3 shows Fourier transform infrared (FTIR) spectra of copolymer II in a 1.0 M solution of hydrochloric acid at different potentials (−0.20 V, 0.45 V, 0.75 V, and 1.00 V) followed by a dedoping treatment in an aqueous solution of 0.1 molar (M) ammonium hydroxide.

FIG. 4 shows UV-VIS spectra of the copolymer II thin film oxidized at different potentials (−0.20 V, 0.45 V, 0.75 V and 1.00 V), followed by the dedoping treatment in an ammonium hydroxide aqueous solution

FIG. 5 shows UV-VIS spectra of a thin film of copolymer II on an ITO-glass electrode at different oxidation potentials in an aqueous 1.0 M HCl solution; and

FIG. 6 shows a plot of the transmittance of a thin film of copolymer II as a square wave potential (−0.2 V and 1.0 V) at applied frequencies of 1 Hz, 0.1 Hz, 0.5 Hz, and 0.05 Hz.

### DETAILED DESCRIPTION

Briefly, the present invention is concerned with soluble, electrochromic, copolymers that are processed more easily than PANI. These copolymers are polyamide copolymers, and may be synthesized by reacting oligoaniline monomers with diacyl chloride compounds. An exemplary oligoaniline monomer includes non-conjugated aromatic and aliphatic groups, and amine-protecting groups (tert-butoxy-carbonyl (BOC), for example). It is believed that these groups play a role in improving the solubility of the copolymers.

An advantage of this invention is related to the solubility of the copolymers as compared to PANI and PANI derivatives. Copolymers of this invention are soluble in volatile solvents such as dichloromethane, chloroform, and acetone, while PANI derivatives have limited solubility in less volatile solvents such as NMP and DMF.

Another advantage of this invention is concerned with the preparation of thin films of the copolymers as compared to PANI and PANI derivatives. Thin films of the copolymer cast from solution are easily prepared because the solvents are easily removed by evaporation at relatively low temperatures. By contrast, thin films of PANI derivatives cast from solution are not as easily prepared because the solvents (NMP and DMF, for example) are higher boiling and require higher temperatures for their removal. In addition, thin-film quality often suffers from the limited solubility of PANI EB (polyaniline emeraldine base) in these higher boiling solvents.

The as-cast films of copolymers of this invention are not electrochromic. However, they become electrochromic upon treatment with acid or by heating them under an argon atmosphere.

Importantly, the electrochromic properties of the invention copolymers were found to be superior to those of PANI.

In particular, the invention includes a polymeric reaction product of a compound of the formula 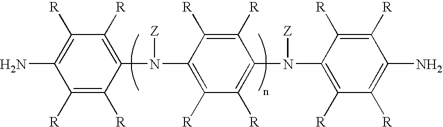
with a compound of formula X(O═)C—R′—C(═O)X; wherein n is an integer greater than 2; wherein R is independently selected from hydrogen, alkyl having 1-12 carbon atoms, aryl, alkyl-substituted aryl, alkoxy having 1-4 carbon atoms, fluoroalkyl having 1-12 carbon atoms, fluoride, chloride, bromide, and iodide; wherein Z is independently selected from hydrogen and —(C═O)OR″ wherein R″ is alkyl having 1-12 carbon atoms; wherein R′ is selected from alkyl having 1-12 carbon atoms, aryl, alkyl-substituted aryl, fluoroalkyl, and fluoroaryl; and wherein X is selected from the group consisting of F, Cl, Br, I, and OH.

The invention also includes a method for preparing a thin film. The method involves dissolving the polymeric reaction product of a first compound and a second compound in a solvent to produce a solution, then casting a film of the solution on a surface, and evaporating the solvent. The first compound has the formula 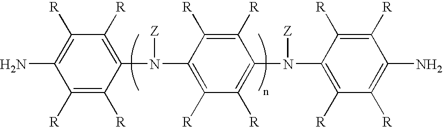
wherein n is an integer greater than 2; wherein R is independently selected from hydrogen, alkyl having 1-12 carbon atoms, aryl, alkyl-substituted aryl, alkoxy having 1-4 carbon atoms, fluoroalkyl having 1-12 carbon atoms, fluoride, chloride, bromide, and iodide; and wherein Z is independently selected from hydrogen and —(C═O)OR″ wherein R″ is alkyl having 1-12 carbon atoms. The second compound is a diacyl halide compound having the formula
X(O═)C—R′—C(═O)X
wherein R′ is selected from alkyl having 1-12 carbon atoms, aryl, alkyl-substituted aryl, fluoroalkyl, and fluoroaryl; and wherein X is selected from the group consisting of F, Cl, Br, I, and OH. When Z is the carbonyl alkoxy-protecting group, the invention also includes exposing the film to acid, which exchanges the carbonyl alkoxy group for hydrogen.

The EXAMPLES that follow, which are given to illustrate embodiments of the present invention, include preparations of exemplary monomers and copolymers of this invention. According to the procedures followed, tetrahydrofuran, methylene chloride, chloroform, and toluene were dried by filtration through alumina. Benzophenone, 4-bromoaniline, 1,4-phenylenediamine dihydrochloride, sodium tert-butoxide, rac-2,2′-Bis (diphenylphosphino)-1,1′-binaphthyl, N,N-(dimethylamino) pyridine, di-tertbutylcarbonate, hydroxylamine hydrochloride, tetrabutylammonium tribromide, isophthaloyl dichloride, terephthaloyl chloride, azelaoyl chloride and dodecanedioyl dichloride were purchased from ALDRICH, INC. and used as received without further purification. The UV-Visible spectra were measured using a PERKIN-ELMER LAMDA 19 instrument. The Fourier transform infrared (FTIR) spectra were obtained from KBr pellets using a NICOLET MAGNA-IR 750. The NMR spectra were measured using a 500-MHz BRUKER DRX 500 system.

### EXAMPLE 1

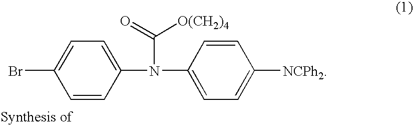

The synthesis of tert-butoxy-carbonyl (BOC) protected compound (1) is based on a literature procedure [15]. Benzophenone (3.64 g, 20.0 mmol), N-phenyl-p-phenylenediamine (3.68 g, 20.0 mmol), 5 Å molecular sieves (10 g), and toluene (10 ml) were put into a round bottom flask that was fitted with a reflux condenser and a rubber septum. The mixture was heated to reflux under a positive pressure of argon. After 24 hours, the solvent was decanted from the molecular sieves. The molecular sieves were washed with CH₂Cl₂ until the filtrate was colorless. The mixture was condensed under vacuum. The residue was dissolved in CH₂Cl₂ (40 ml) and treated with tetrabutylammonium tribromide (1.69 g, 24.2 mmol). After being stirred for 30 min, a saturated aqueous Na₂SO₃ solution (40 ml) was added, and the mixture was stirred for 10 min. It was then diluted with 2.0 M NaOH, and the organic layer and aqueous layer were separated. The organic layer was washed with brine (40 ml) and dried over anhydrous Na₂SO₄. After being concentrated under vacuum, the residue and 4-methylaminopyridine (4-DMAP) (268 mg, 2.20 mmol) were dissolve in THF (25 ml), and di-butyl-carbonate, (28.6 mmol) in THF (30 ml) was added. After being refluxed for 24 hours, a crude product (7.04 g) was collected under vacuum and purified by washing with isopropanol. Compound (1) was characterized by NMR and IR spectroscopy. ¹H-NMR (500 MHz, CDCl₃) δ 7.75 (d, 2H), 7.47-7.35(m, 6H), 7.28 (d, 2H), 7.12 (d,2H), 7.03 (d, 2H), 6.94 (d, 2H), 6.68 (d, 2H), 13.9 (s, 9H). IR (KBr pellet): 2980, 2930, 1700, 1630, 1510, 1340, 1290, 1160, 1060, 957, 833, 764, 602, 540 cm⁻¹.

### EXAMPLE 2

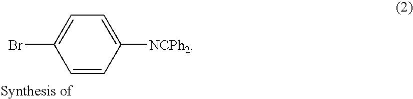

N-(Diphenylmethylene)-4-bromoaniline (2) was synthesized as follows: Benzophenone (45.5 g, 0.250 mol), 4-bromoaniline (47.3 g, 0.275 mol), 5 Å molecular sieves (125 g) and toluene were heated to reflux in a round bottom flask fitted with a reflux condenser, rubber septum, under a positive pressure of argon. After 24 hours, the mixture was filtered and the molecular sieves were washed with diethyl ether until the filtrate was colorless. The filtrate was concentrated under vacuum to give a residue. Yellow crystals of compound (2) were obtained by recrystallizing the residue from methanol. Compound (2) was characterized using NMR and IR spectroscopy. ¹H-NMR (500 MHz, CDCl₃): δ 7.77 (d, 2H), 7.54-7.40 (m 3H), 7.33-7.23(m, 5H), 7.12 (d, 2H), 6.63 (d, 2H). IR (KBr pellet): 3050, 3020, 1610, 1480, 1440, 1300, 1230, 1140, 1070, 1010, 957, 918, 825, 779, 702, 663, 609, 583, 525 cm⁻¹.

### EXAMPLE 3

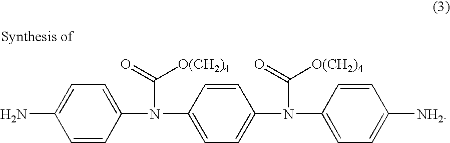

A mixture of 1,4-phenylenediamine dihydrochloride (4.25 g, 12.64 mmol), N-(diphenylmethylene)-4-bromoaniline (2) (1.13 g, 6.24 mmol), sodium tert-butoxide (2.7 g) and rac-2,2′-bis(diphenylphosphino)-1,1′-binaphthyl (BINAP, 59 mg) in toluene (50 ml) was heated in a round bottom flask with magnetic stirring to a temperature of 80 degrees Celsius under argon. After 24 hours, the mixture was cooled to room temperature and N,N-(dimethylamino) pyridine (76 mg, 0.625 mmol), di-tert-butyl dicarbonate (4.78 g, 21.88 mmol) and tetrahydrofuran (35 ml) were added. The heating was resumed for another 24 hours. Then the mixture was poured into 100 ml of hot ethanol. A gray product precipitated from the solution and was collected by filtration. The crude product was combined with hydroxylamine hydrochloride (1.08 g) in a solvent mixture of pyridine (2.00 ml), chloroform (100 ml), THF (25 ml) and ethanol (12.5 ml) and stirred. After 3 hours, triethylamine (8.7 ml) was added and the resulting suspension was stirred for an additional 3 hours. The suspended mixture was concentrated, and the residue solid was heated in a mixture of 2-propanol (150 ml), chloroform (30 ml), and water (15 ml) for 10 min. The mixture was then allowed to cool to room temperature and stand for 12 h. The precipitated product was collected by filtration and washed, first with water and then with 2-propanol. Compound (3) (2.3 g, 75.0%) was obtained as a solid after drying under vacuum. Compound (3) was characterized by NMR and IR spectroscopy. ¹H-NMR(500 MHz, DMSO-d₆): δ 7.06 (s, 4H), 6.83 (d, 4H), 6.51 (d, 4H), 5.12 (s, 4H), 1.34(s, 18H). IR (KBr pellet): 2980, 1710, 1620, 1500, 1330, 1160, 1070, 1010, 957, 833, 771, 702 cm⁻¹.

### EXAMPLE 4

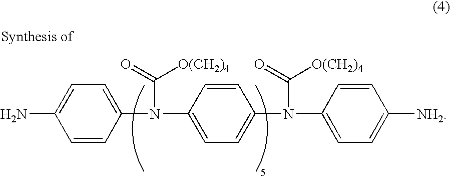

A mixture of compound (3) (490 mg, 1.0 mmol), compound (1) (1.11 g, 2.1 mmol), Pd(OAc)₂ (13.5 mg, 0.06 mmol), sodium tert-butoxide (288 mg, 3.0 mmol), R-BINAP ((R)-(+)-2,2′-Bis(diphenylphosphino)-1′1-binaphthyl, 44 mg, 0.07 mmol) and triethylamine (1.3 ml) in toluene (5 ml) was heated at a temperature of 90 degrees Celsius with magnetic stirring under argon. After 24 hours, heating was stopped temporarily, and N,N-(dimethylamino) pyridine (12.2 mg, 0.1 mmol), di-tert-butyl dicarbonate (873 mg, 4.0 mmol) in tetrahydrofuran (7 ml) were added and the resulting mixture was heated for another 24 hours. The reaction mixture was poured into 10 ml of hot ethanol, and the precipitate was collected by filtration. The precipitate was mixed with ammonium formate (3.14 g), Pd(OH)₂ on carbon (698 mg), THF (60 ml) and ethanol (30 ml) and then heated to 70 degrees for 1.5 hours. The mixture was filtrated and the filtrate was evaporated under vacuum to produce a residue. The residue was dissolved in CH₂Cl₂ (15 ml) and washed with 2 N aqueous NaOH, followed by brine. The organic layer was evaporated, and a final product was obtained after the residue was washed with a 1:1 solvent mixture of hot hexane and isopropanol. Characterization: ¹H-NMR (500 MHz, CDCl₃) δ 7.19-7.08 (m, 20H), 6.97 (d, 4H), 6.62 (d, 4H), 3.68 (s, 4H), 1.42 (s, 54H). IR: 2980, 2930, 1700, 1630, 1510, 1330, 1160, 1060, 957, 849, 771, 548 cm⁻¹.

### EXAMPLE 5

Synthesis of copolymer of compound (4) and isophthaloyl dichloride. Compound 4 (200 mg, 0.159 mmol, prepared according to EXAMPLE 4) and an equimolar amount of isophthaloyl dichloride, and triethylamine (66 ul) were dissolved in 1.2 ml chloroform at 0 degrees Celsius and then warmed to room temperature. After being stirred overnight, chloroform (10 ml) was added, and the resulting mixture was washed with water and dried over sodium sulfate. The solvent was evaporated under vacuum to produce copolymer I as a colorless powder. The product copolymer I was characterized by NMR and IR spectroscopy. ¹H-NMR (500 MHz, CDCl₃): δ9.05 (1H, m), 8.24 (1H, m), 7.92 (2H, m), 7.58 (4H, m), 7.12-7.03 (24H, m), 1.43 (18H, s), 1.42 (36H, s) ppm. IR (KBr pellet: 2980, 2930, 1710, 1600, 1510, 1330, 1300, 1160, 1060, 957, 849, 764, 717, 617, 555 cm⁻¹

### EXAMPLE 6

Synthesis of copolymer of compound (4) and terephthaloyl chloride. Copolymer II was prepared according to the procedure of EXAMPLE 5, with the exception that terephthaloyl chloride was used instead of isophthaloyl dichloride. azelaoyl chloride and dodecanedioyl dichloride. The product copolymer II was characterized by NMR and IR spectroscopy. ¹H-NMR (500 MHz, CDCl₃): δ7.72-7.63 (8H, m), 7.16-7.07 (24H, m), 1.43 (18H, s), 1.42 (36H, s) ppm. IR (KBr pellet): 2980, 2940, 1710, 1600, 1510, 1330, 1260, 1160, 1060, 957, 849, 764, 555 cm⁻¹

### EXAMPLE 7

Synthesis of copolymer of compound (4) and azelaoyl chloride. Copolymer III was prepared according to the procedure of EXAMPLE 5, with the exception that azelaoyl chloride was used instead of isophthaloyl dichloride. The product copolymer III was characterized by NMR and IR spectroscopy. ¹H-NMR (500 MHz, CDCl₃): δ7.47 (4H, d, J=8.3 Hz), 7.11 (24H, s), 2.28-2.22 (4H, m), 1.67-1.61 (4H, m) 1.43 (54H, s). IR (KBr pellet): 2980, 2930, 1710, 1600, 1510, 1330, 1160, 1060, 957, 849, 764, 548 cm⁻¹

### EXAMPLE 8

Synthesis of copolymer of compound (4) and dodecanedioyl chloride. Copolymer IV was prepared according to the procedure of EXAMPLE 5, with the exception that dodecanedioyl chloride was used instead of isophthaloyl dichloride.

The product copolymer IV was characterized by NMR and IR spectroscopy. ¹H-NMR (500 MHz, CDCl₃): δ 7.45 (4H, d, J=8.4 Hz), 7.12 (24H, s), 2.30-2.27 (4H, m), 1.70-1.64 (4H, m), 1.44 (18H, s). IR (KBr pellet): 2980, 2930, 1710, 1600, 1510, 1330, 1160, 1060, 957, 841, 764, 555 cm⁻¹

The molecular weights of invention copolymers were determined by gel permeation chromatography using a WATERS GPC system equipped with an AM GPC gel column and KNAUER DRI detector. The copolymers were dissolved in methylene chloride and then 25 μl of solution were injected with a flow rate of 1.0 ml/min under a controlled temperature at 30 degrees Celsius. TABLE 1 summarizes the molecular weight data of copolymers I, II, and III.

TABLE 1

| Copolymer | Mₙ | M_{w} | M_{z} | M_{w}/Mₙ |
|---|---|---|---|---|
| Copolymer I | 2,475 | 3,550 | 4,700 | 1.43 |
| Copolymer II | 8,675 | 17,460 | 28,100 | 2.04 |
| Copolymer III | 12,200 | 27,850 | 47,300 | 1.43 |

As TABLE 1 shows, copolymer 1 exhibits a relatively low molecular weight of about 3,550, averaging 2.5 repeating units (repeat unit M_{w}, 1,384). Copolymer 2 has a much higher molecular weight (17,650), averaging 13 repeat units (repeat unit M_{w}, 1,384). The para-substituted terephthaloyl dichloride used for preparing copolymer II likely allowed the chain to grow much longer than the meta-substituted isophthaloyl dichloride used for preparing copolymer 1. The flexible monomer dodecanedioyl dichloride produced an even higher molecular weight copolymer III (about 27,850), averaging 19 repeat units (repeat unit Mw, 1,448). While not intending to be bound by any particular explanation, it appears that steric effects likely play an important role in determining the length (and therefore, the molecular weight) of copolymer chains.

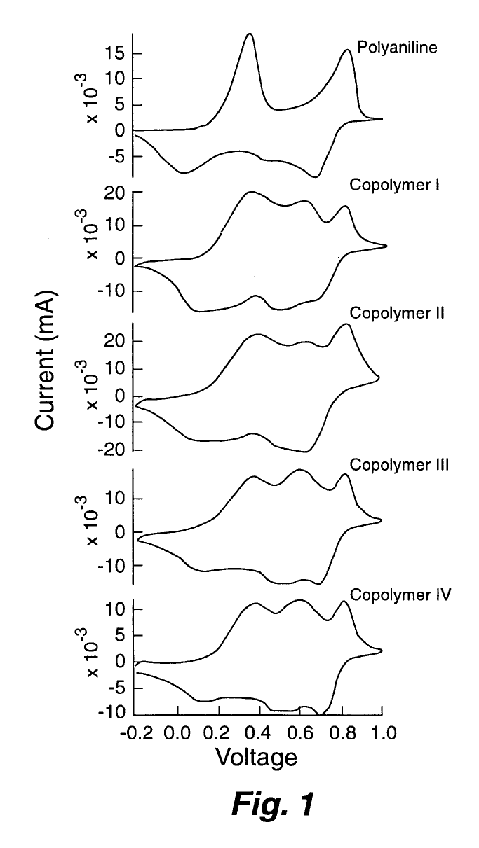

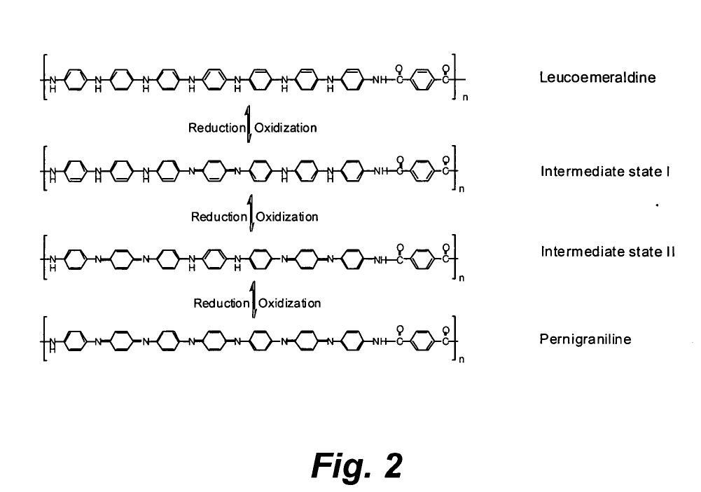

Electrochemical characterization of invention copolymer thin films was performed in 1.0 aqueous hydrochloric acid using a CHI660 Electrochemical Workstation. A compact, three-electrode system connected to the CHI660 system that fits in a quartz cell was placed in a UV-VISIBLE sample holder. Transmission measurements were performed at a detector wavelength setting of 600 nm. FIG. 1 shows a cyclic voltammagram of copolymers I-IV and polyaniline. The voltammagram was obtained in an aqueous solution of 1.0 M HCl using Ag/Ag+ as a reference electrode with a scan rate of 50 mV/sec. The copolymers used were cast as thin films from chloroform solutions on a platinum sheet. The films were heated at a temperature of 180 degrees Celsius to remove the protecting BOC groups. As FIG. 1 shows, the cyclic voltammagram for polyaniline has two pairs of redox peaks. One of these peaks corresponds to a transition from the leucoemeraldine base form to emeraldine base form, and the other transition corresponds to the transition from the emeraldine base form to pernigraniline base form. By contrast, each of the copolymers includes three oxidation peaks at voltages of about 0.4 V, about 0.7 V, and about 0.8 V. It is believed that the first oxidation peak corresponds to a transition from the leucoemeraldine form to a first intermediate state, the second peak corresponds to a transition from first intermediate state to a second intermediate state, and the third peak corresponds to the transition from the second intermediate state to the pernigraniline base form. Without wishing to be bound by any particular explanation, it is believed that differences in electrochemical behavior between the copolymers and PANI are due mainly to their differences in chemical structure. For the case of copolymer II, for example, after the oligoaniline is copolymerized with isophthaloyl dichloride to form copolymer II (EXAMPLE 5), the two terminal amine functional groups are not involved in the electrochemical reaction. It is believed that the oligoaniline segments in the copolymer cannot form an exact EB form of two amine groups and two imine groups as PANI can. Instead, as is illustrated in FIG. 2, the copolymer is transformed from a leucoemeraldine base (LEB) form to an intermediate form (intermediate state I as depicted in FIG. 2) having one quinoid ring on each oligoaniline segment. Afterward, the copolymer is transformed to a second intermediate form (intermediate state II as depicted in FIG. 2) with two quinoid rings on each oligoaniline segment, and finally to pernigraniline base (PNB) form. By contrast, PANI has only one intermediate form. A possible explanation for this difference is that PANI has many more aniline repeat units than the copolymer has, and as the form of PANI changes from the LEB form to a more oxidized form, it may also have many more quinoid rings in the polymer chains, and therefore a “continuum of forms” (i.e. oxidation states). Studies by MacDiarmid et al. show, however, that LEB conversion to EB and EB conversion to PB occur in one step without passing through an intermediate having a discrete oxidation state [12]. While MacDiarmid states that there are three allowable forms for PANI, our results show only one intermediate form between the LEB form and the PNB form.

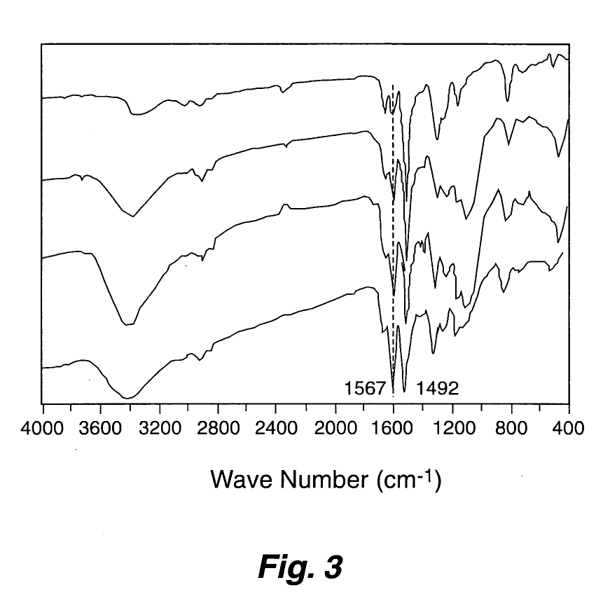

Changes in the oxidation state of the oligoaniline segments in the copolymer backbone were confirmed using Fourier transform infrared (FTIR) spectroscopy and ultraviolet-visible (UV-VIS) spectroscopy. FIG. 3 shows Fourier transform infrared (FTIR) spectra of copolymer II in a 1.0 M solution of hydrochloric acid at different potentials (−0.20 V, 0.45 V, 0.75 V, and 1.00 V) followed by a dedoping treatment in an aqueous solution of 0.1 M ammonium hydroxide. The bands at 1567 and 1492 cm⁻¹ correspond to the stretching of an N═Q═N and N—B—N unit in the polymer chain, respectively (Q represents the quinoid ring and B represents the benzene ring structure). The band at 1650 cm⁻¹ group corresponds to the stretching of the C═O of amide group and the band at 816 cm⁻¹ corresponds to the deformation of CH out of the plane vibrational mode. For polyaniline, the relative intensities of the peak at 1567 cm⁻¹ to the peak at 1492 cm⁻¹ increase with the increasing numbers of quinoid rings in the polymer backbone structure [13]. As seen in FIG. 3, the intensity peak ratio of 1567 cm⁻¹/1492 cm⁻¹ increases as the oxidation potential is increased from −0.20 V to 0.45 V to 0.75 V to 1.00 V. This result suggests that the relative numbers of quinoid rings in the oligoaniline segments increases with increasing oxidative potential.

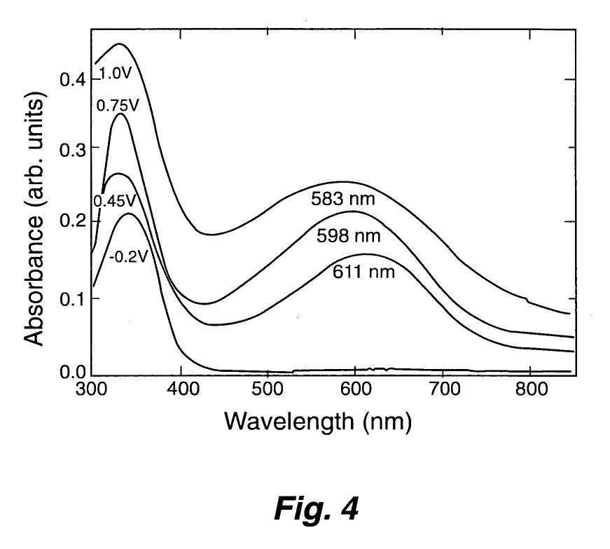

FIG. 4 shows UV-VIS spectra of the copolymer II thin film oxidized at different potentials (−0.20 V, 0.45 V, 0.75 V and 1.00 V), followed by the dedoping treatment in an ammonium hydroxide aqueous solution. According to FIG. 4, the copolymer oxidized at −0.20 V shows only one sharp peak at about 330 nm, which suggests that the copolymer is in the leucoemeraldine base form. The copolymers oxidized at 0.45 V, 0.75 V, and 1.00 V show two absorption peaks: one sharp peak at about 330 nm and a second broad band at about 600 nm. The 330 nm peak has been associated with the π-π* transition, and the peak at about 600 nm has been referred to as the “exciton” peak, which is directly associated with the quinone diimine structure [14]. The exciton peak for copolymers (<611 nm) is blue shifted from the exciton peak at 636 nm that is typically observed for PANI EB thin films cast from n-methyl-2-pyrrolidinone solution. The oxidations of the copolymer at 0.45 V, 0.75 V and 1.00 V are associated with exciton peaks at 611 nm, 598 nm, and 583 nm, respectively which suggests that the effective conjugated length increases from a pernigraniline base to an intermediate form I to intermediate form II (see FIG. 2).

Copolymer thin films exhibit electrochromic behavior during a redox cycle. A thin film of copolymer II, for example, undergoes color changes from yellow (at about −0.2 V), to green (at about 0.45 V), to blue (at about 0.75 V), and finally to purple (at about 1.00 V) when a linear potential sweep from −0.20 V to 1.00 V with a scanning rate of 100 mV/S is applied.

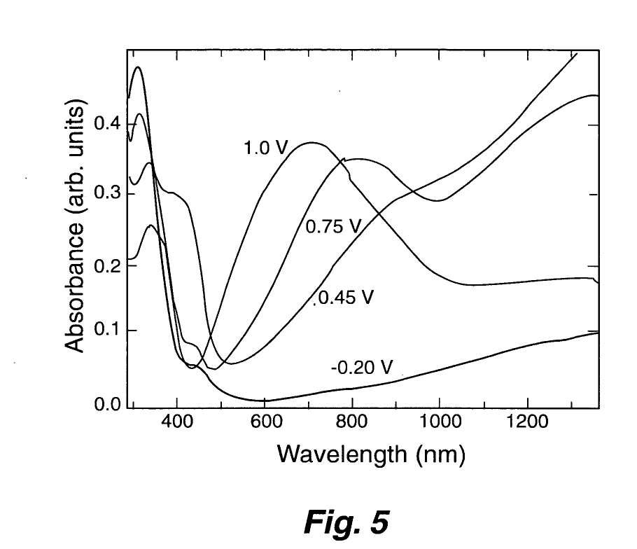

FIG. 5 shows UV-VIS spectra of a thin film of copolymer II oxidized at different potentials on an ITO-glass electrode in an aqueous solution of 1.0 M HCl in a quartz cuvette. The set-up also included a silver wire as a reference electrode and a platinum wire as a counter electrode. The UV-VIS spectra were monitored at a constant voltage. FIG. 5 shows that copolymer oxidized at −0.20 V produces only one peak at 300 nm and a minimum absorbance at the visible and near IR region. This suggests that the copolymer thin film is in the leucoemeraldine state. When the copolymer was oxidized at 0.45 V or 0.75 V, a strong absorbance in the visible and near IR regions was observed. This strong absorbance is believed to result from the delocalization of the radical cation (i.e. the polaron) along the doped copolymer backbone structure. The position and shape of the polaron band are determined mainly by the oxidation states and polymer conformations. The extended chain conformation has an increased conjugated length and a smaller band-gap energy, which leads to delocalization of polarons and a higher intensity of the free-carrier tail into the NIR region. This also suggests that the doped copolymers in the intermediate form I and intermediate form II are conductive.

The copolymers show a much lower intensity in the free-carrier tail and a blue shift of the polaron band when oxidized at 1.00 V. The UV-VIS spectra suggest that doped pernigraniline (fully oxidized copolymer) is not as conductive as the doped copolymer in intermediate form I and intermediate form II.

The copolymer thin films of this invention adhered to ITO glass more strongly than did PANI. Copolymer II thin film was electrochemically stable and adhered to ITO even after hundreds of redox cycles. By contrast, the degradation and delamination of PANI occurs much sooner.

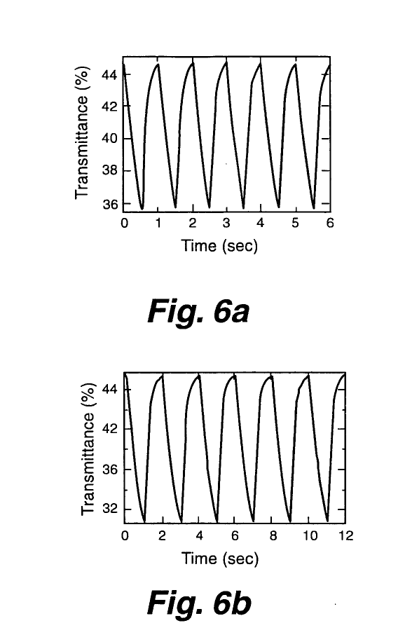

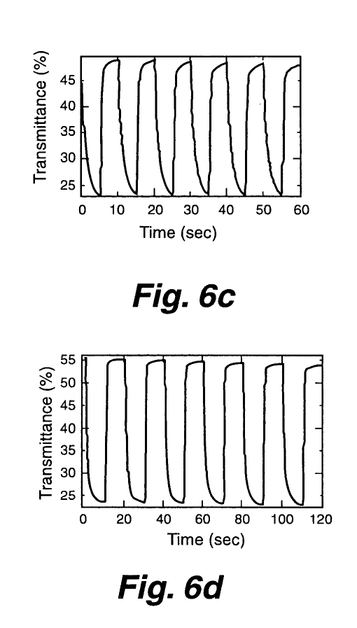

The optical and electrochemical responses of invention copolymer thin films were measured. FIG. 6 shows a plot of the transmittance of a thin film of copolymer II as a square wave potential (−0.2 V and 1.0 V) at applied frequencies of 1 Hz, 0.1 Hz, 0.5 Hz, and 0.05 Hz. The detector wavelength was set at 600 nm and 1.0V. FIG. 6 shows copolymer II switching from a transmittance of 56 percent at −0.2 V to a transmittance of 22 percent at 1.0 V. As the frequency was increased from 0.1 Hz to 1 Hz, the difference in the transmittance between two oxidation states decreased from 34 percent to 9 percent. These results illustrate the conversion of invention copolymer from the fully oxidized form to the fully reduced form.

Similar results were observed for copolymers I, III, and IV in terms of their electrochromic responses. It is believed that the electrochromic properties of the invention copolymers are largely determined by the diffusion of the electrolyte in and out of the copolymer thin film.

In summary, electrochromic polyamide copolymers were prepared by condensation N-protected aniline oligomers and diacyl halides. Films cast from solutions of the copolymers displayed electrochromic properties after treatment with acid or heat. The copolymer films were easy to prepare, are electrochemically stable, and adhere to ITO even after hundreds of redox cycles.

The foregoing description of the invention has been presented for purposes of illustration and description and is not intended to be exhaustive or to limit the invention to the precise form disclosed, and obviously many modifications and variations are possible in light of the above teaching. While this invention has been described fully and completely, it should be understood that, within the scope of the appended claims, the invention may be practiced otherwise than specifically described.

The embodiment(s) were chosen and described in order to best explain the principles of the invention and its practical application to thereby enable others skilled in the art to best utilize the invention in various embodiments and with various modifications as are suited to the particular use contemplated. Although the invention has been disclosed with reference to its preferred embodiments, from reading this description those of skill in the art can appreciate changes and modifications that may be made which do not depart from the scope and spirit of the invention as described above and claimed hereafter. It is intended that the scope of the invention be defined by the claims appended hereto.

### REFERENCES

The following references are incorporated by reference herein.
1. A. G. MacDiarmid, S.-L. Mu, N. L. D. Somasiri, W. Wu, Mol. Cryst. Liq. Cryst. (1985), vol. 121, pp. 187-.
2. T. Kobayashi, H. Yoncyama, H. amura, J. Electroanal. Chem. Interfacial Electrochem. (1984), vol. 161, pp. 419-423.
3. (a) K. Kaneto, M. Kaneko, Y. Min, A. G. MacDiarmid, Synth. Met. 1995, 71, 2211. (b) W. Takashima, M. Kaneko, K. Kaneto, A. G. MacDiarmid, Synth. Met. 1995, 71, 2265. (c) J. M. Sansiñena, J. Gao, H.-L. Wang, Adv. Funct. Mater. 2003, 13 (9), 703. (d) J. Gao, J. M. Sansiñena, H.-L. Wang, Chem. Mater. 2003, 15 (12), 2411.
4. (a) D. W. Deberry, J. Electrochem. Soc. 1985, 132, 1022. (b) N. Ahmad, A. G. MacDiarmid, Synth. Met. 1996, 78, 103. (c) W.-K. Lu, R. L. Elsenbaumer, B. Wessling, Synth. Met. 1995, 71, 2163.
5. (a) T. Taka, Synth. Met. 1991, 41, 1177. (b) N. F. Colaneri, L. W. Shacklette, IEEE Trans. Instrum. Meas. 1992, 21, 291. (c) J. Joo, A. J. Epstein, Appl. Phys. Lett. 1994, 65, 2278.
6. (a) L. X. Wang, T. Soczka-Guth, E. Havinga, K. Mullen, Angew. Chem. Int. Ed. Engl. 1996, 35, 1495.
7. (a) W. H. Jang, B. J. Kim, H. J. Choi, M. S. Jhon, Colloid Polym. Sci. 2001, 279, 823. (b) W. Luzny, E. J. Samuelsen, D. Djurado, Y. F. Nicolau, Synth. Met. 1997, 90, 19. (c) Y. Haba, E. Segal, M. Narkis, G. I. Titelman, A. Siegmann, Synth. Met. 1999, 106, 59. (d) S. Kabaya, M. Appel, Y. Haba, G. I. Titelman, A. Schmidt, Macromolecules 1999, 32, 5357. (e) Y. Haba, E. Segal, M. Narkis, G. I. Titelman, A. Siegmann, Synth. Met. 2000, 110, 189. (f) S. J. Su, N. Kuramatto, Synth. Met. 2000, 108, 121. (g) W. Yin, E. Ruchkenstien, Synth. Met. 2000, 108, 39. (I) Y. Cao, A. Andreatta, A. J. Heeger, P. Smith, Polym. 1989, 30, 2305.
8. (a) V. Prevost, A. Petit, F. Pla, Synth. Met. 1999, 104, 79. (b) M. T. Nguyen, P. Kasai, J. L. Miller, A. F. Diaz, Macromolecules 1994, 27, 3625. (c) L. May, M. Zigon, Polym. Bull. 2000, 45, 61.
9. (a) D. Yang. B. R. Mattes, Synth. Met. 1999, 101, 746. (b) H. L. Wang, B. R. Mattes, Synth. Met. 1999, 102, 1333.
10. P. J. Kinlen, B. G. Frushour, Y. Ding, V. Menon, Synth. Met. 1999, 101, 758.
11. (a) F. Garnier, G. Horowitz, X. Peng, D. Fichou, Adv. Mater. 1990, 2, 592. (b) G. Horowitz, D. Fichou, X. Peng, Z. Xu, F. Garnier, Solid State Commun. 1989, 72, 381.
12. J. G. Masters, Y. Sun, A. G. MacDiarmid, A J. Epstein, Synth. Met. 1991, 41-43, 715.
13. (a) F.-L. Lu, F. Wudl, M. Novack, A. J. Hegger, J. Am. Chem. Soc. 1986, 108, 8311. (b) L. W. Shacklette, J. F. Wolf, S. Gould, R. H. Baughman, J. Chem. Phys. 1988, 88, 3955. (c) J. Tang, X. Jing, B. Wang, F. Wang, Synth. Met. 1988, 24, 231. (d) S. Quillard, G. Lourarn, J. P. Buisson, S. Lefrant, J. Masters, A. G. MacDiarmid, Synth. Met. 1993, 55. 475.
14. J. G. Masters, J. M. Ginder, A. G. MacDiarmid, A J. Epstein, J. Chem. Phys. 1992, 96, 4768.
15. (a) R. A. Singer, J. P. Sadighi, S. L. Buchwald, J. Am. Chem. Soc. 1998, 120, 213. (b) J. P. Sadighi, R. A. Singer, S. L. Buchwald, J. Am. Chem. Soc. 1998, 120, 4960.

What is claimed is:

1. A polymeric reaction product of a compound of the formula 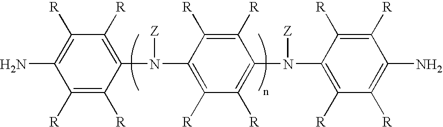
with a compound of formula X(O═)C—R′—C(═O)X;
wherein n is an integer greater than 2;
wherein R is independently selected from hydrogen, alkyl having 1-12 carbon atoms, aryl, alkyl-substituted aryl, alkoxy having 1-4 carbon atoms, fluoroalkyl having 1-12 carbon atoms, fluoride, chloride, bromide, and iodide;
wherein Z is independently selected from hydrogen and —(C═O)OR″ wherein R″ is alkyl having 1-12 carbon atoms;
wherein R′ is selected from alkyl having 1-12 carbon atoms, aryl, alkyl-substituted aryl, fluoroalkyl, and fluoroaryl; and
wherein X is selected from the group consisting of F, Cl, Br, I, and OH.

2. A method for preparing a film comprising dissolving the polymeric reaction product of a first compound and a second compound in a solvent to produce a solution, casting a film of the solution on a surface, and evaporating the solvent, the first compound having a formula 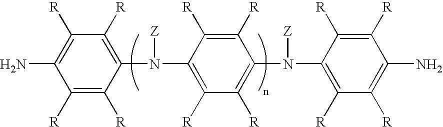
wherein n is an integer greater than 2; wherein R is independently selected from hydrogen, alkyl having 1-12 carbon atoms, aryl, alkyl-substituted aryl, alkoxy having 1-4 carbon atoms, fluoroalkyl having 1-12 carbon atoms, fluoride, chloride, bromide, and iodide; and wherein Z is independently selected from hydrogen and —(C═O)OR″ wherein R″ is alkyl having 1-12 carbon atoms;
the second compound having a formula
X(O═)C—R′—C(═O)X
wherein R′ is selected from alkyl having 1-12 carbon atoms, aryl, alkyl-substituted aryl, fluoroalkyl, and fluoroaryl; and wherein X is selected from the group consisting of F, Cl, Br, I, and OH.

3. The method of claim 2, further including the step of exposing the film to acid when Z is —(C═O)OR″.

4. The method of claim 2, further including the step of heating the film after casting the film on a surface.
